(19) United States
(12) Patent Application Publication
(10) Pub. No.: US 2003/0132175 A1
(43) Pub. Date: Jul. 17, 2003

(54) Ceramic filter oil and water separation

(76) Inventors: Alexander Kiderman, Pittsburgh, PA (US); Steven R. Evanovich, Pittsburgh, PA (US); Jason Williams, Raleigh, NC (US)

Correspondence Address: WEBB ZIESENHEIM LOGSDON ORKIN & HANSON, P.C., 700 Koppers Building, 436 Seventh Avenue, Pittsburgh, PA, 15219-1818, US

(21) Appl. No.: 10/313,999

(22) Filed: Dec. 6, 2002

Related U.S. Application Data
(60) Provisional application No. 60/339,003, filed on Dec. 7, 2001.

(51) Int. Cl. B01D 37/00

(52) U.S. Cl. 210/770; 210/799; 210/806; 210/490; 210/506; 210/510.1

(57) ABSTRACT

A filter element for separating a water from a petroleum-based fluid, the filter element having a hollow, fluid permeable porous support structure, a fluid permeable first ceramic coating positioned adjacent to the support structure, and a fluid permeable second ceramic coating positioned adjacent to the fluid permeable first ceramic coating, and a thin film of dry petroleum-based fluid, wherein the thin film of dry petroleum-based fluid substantially coats the filter element and permeates the fluid permeable porous support structure, the fluid permeable first ceramic coating, and the fluid permeable second ceramic coating, the dry petroleum-based fluid having a water content of approximately 100 ppm or less.

### BACKGROUND OF THE INVENTION

1. Field of the Invention

The present invention relates to filters and, more particularly, to ceramic filters which separate water from a petroleum-based fluid.

2. Description of Related Art

Emulsified water, dissolved water, and freely associated water are common contaminates in desired fluids, such as oil, hydraulic fluid, or kerosene. Emulsified water, which is generally defined as a stable suspension of water in a second liquid, is much more damaging to equipment than dissolved water or freely-associated water. In a macroemulsion, the size of each water droplet is generally 0.2-50.0 microns in diameter. In a microemulsion, the size of each water droplet is generally 0.01-0.20 microns in diameter.

### SUMMARY OF THE INVENTION

The present invention is generally directed toward a filter and a corresponding filtration method for separating a contaminant from a desired fluid, such as separating water from petroleum-based fluid. The filter generally includes at least one filter element having a hollow support structure, a first ceramic coating positioned adjacent to the support structure, and a second ceramic coating positioned adjacent to the first ceramic coating.

The support structure, preferably made from alumina, may have a thickness of approximately 6 mm and may further define a plurality of fluid permeable pores each approximately 5 microns in diameter.

The first ceramic coating is positioned adjacent to the support structure. The support structure is preferably made from a group consisting of α-activated alumina and zirconia, may have a thickness of approximately 20 microns, and also defines a plurality of fluid permeable pores each having a diameter of approximately 0.80 microns.

The second ceramic coating is preferably selected from the group consisting of zirconia and activated alumina and is positioned adjacent to the first ceramic coating. The second ceramic coating may have a thickness of approximately 10 microns and may define a plurality of fluid permeable pores approximately 0.2 microns in diameter.

A thin film of a dry petroleum-based fluid is also provided, wherein the thin film of dry petroleum coats an external surface of the second ceramic coating. The dry petroleum-based fluid preferably has a water content of approximately 100 ppm or less.

One method of separating a contaminant from a desired fluid, such as separating water from a wet petroleum-based fluid, generally includes the steps of (a) providing a filtration system; (b) providing a filter element, the filter element comprising a hollow, fluid permeable porous support structure, a first ceramic, fluid permeable coating positioned adjacent to the porous support structure, and a second ceramic, fluid permeable coating positioned adjacent to the first ceramic coating; (c) soaking the filter element with a dry petroleum fluid, the dry petroleum fluid having a water content of approximately 100 ppm or less; (d) installing the soaked filter element in the filtration system; (e) flowing a wet petroleum-based fluid through the filter element; and (f) removing water from the wet petroleum-based fluid. A step of (g) agitating the wet petroleum-based fluid to form an emulsion of water and a petroleum-based fluid may be included after the step of soaking the ceramic filter element and prior to the step of flowing a wet petroleum-based fluid through the filter element.

The step of flowing a wet petroleum-based fluid through the filter element may be done by pumping the wet petroleum-based fluid or the emulsion tangentially to the filter surface at approximately 7-15 feet per second. Another step may include back-pulsing dry petroleum fluid through the filter element in periodic increments after the step of removing water from the wet petroleum-based fluid or the emulsion, wherein the periodic increment may be one back pulse lasting approximately one second approximately twice per minute. Additional steps may include substituting alumina with zirconia in the second ceramic coating to switch from separation to coalescence or substituting the zirconia with alumina to switch from coalescence to separation.

These and other advantages of the present invention will be clarified in the description of the preferred embodiments taken together with the attached drawings in which like reference numerals represent like elements throughout.

### BRIEF DESCRIPTION OF THE DRAWINGS

FIG. 1 is a partial, cross-sectional view of a filter element according to the present invention;

FIG. 2 is a partial, cross-sectional view of a filter having one or more filter elements, wherein the filter is installed in a filter housing;

FIG. 3 is a schematic of a first embodiment fluid filtering system according to the present invention; and

FIG. 4 is a schematic of a test bench used to test the present invention.

### DESCRIPTION OF THE PREFERRED EMBODIMENTS

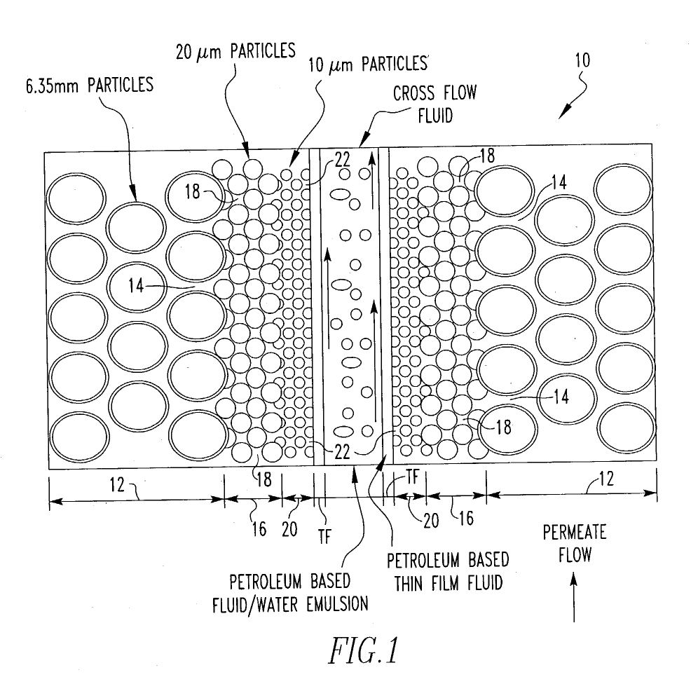

FIG. 1 illustrates a filter element 10 according to a first embodiment of the present invention. Each first embodiment filter element 10 has support structure 12 preferably including alumina (Al₂O₃) and having a thickness of approximately 0.25 inch. The support structure 12 is preferably defines fluid permeable support pores 14, with each support pore 14 defined by the support structure 12 having a diameter of approximately 5 microns.

With continuing reference to FIG. 1, a first ceramic coating 16 is preferably positioned adjacent to the support structure 12. The first ceramic coating 16 defines a plurality of fluid permeable first pores 18 and is preferably made from a group consisting of α-activated alumina and zirconia having a thickness of approximately 20 microns. Each first pore 18 defined by the first ceramic coating 16 preferably has a diameter of approximately 0.80 microns.

A second ceramic coating 20, preferably made from a material selected from the group of activated alumina or zirconia, has a thickness of approximately 10 microns, and defines a plurality of fluid permeable second pores 22. The second ceramic coating 20 is positioned adjacent to the first ceramic coating 16. The second pores 22 defined by the second ceramic coating 20 generally each have a pore diameter of approximately 0.2 microns.

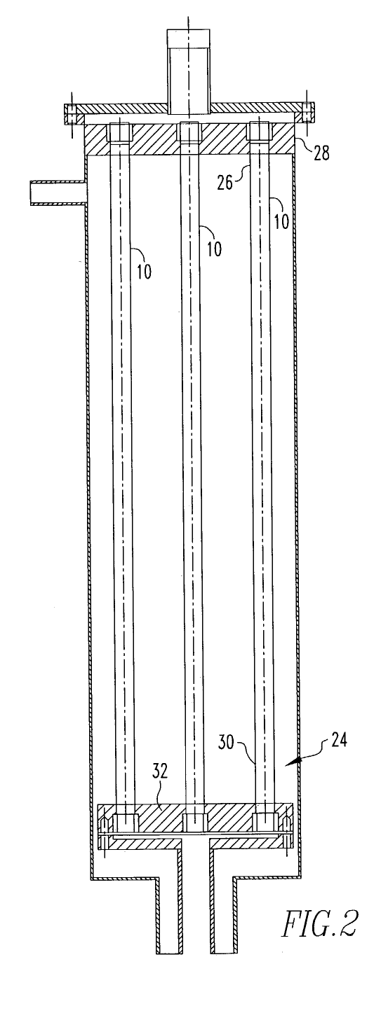

As shown in FIG. 2, a plurality of filter elements 10 may be combined to form a filter 24. Each filter element 10 may be connected at a first end 26 to a first sealing member 28 and connected at a second end 30 to a second sealing member 32. According to the present invention, the filter 24 is preferably soaked by flushing or pressure submerging the filter 24 with dry petroleum-based fluid for approximately one or more hours. A dry petroleum-based fluid is herein defined as a fluid having a low water content, such as a water content of approximately 100 ppm or less. As shown in FIG. 1, the soaking procedure allows a thin film TF of dry petroleum-based fluid to substantially uniformly coat the second ceramic coating 20, shown in FIG. 1, and permeate through the first pores 18, the second pores 22, and the support pores 14.

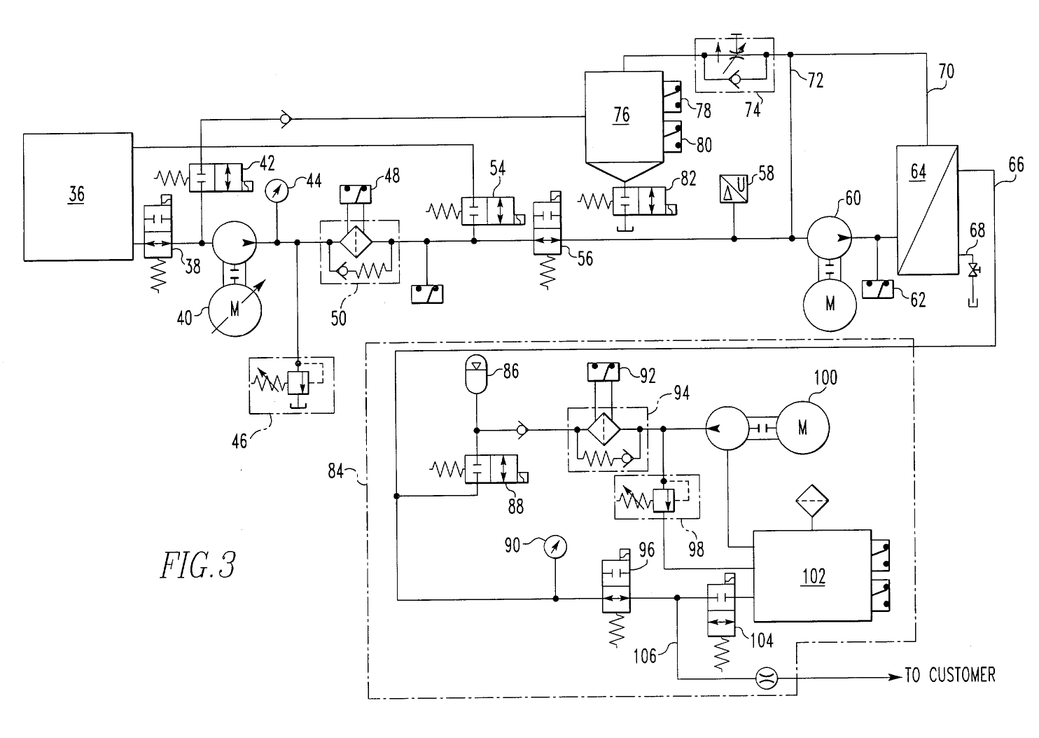

FIG. 3 shows a first embodiment filtration system according to the present invention. The filtration system generally includes a first reservoir 36 fluidly connected to a first solenoid valve 38, a pump 40, such as a 2-10 gpm pump, and a second solenoid valve 42. The pump 40 is fluidly connected to a pressure gauge 44, a relief valve 46, and a first pressure indicator 48. The first pressure indicator 48 is fluidly connected to a prefilter 50, which, in turn, is fluidly connected to a low temperature switch 52, a third solenoid valve 54 fluidly connected to the first reservoir 36, and a fourth solenoid valve 56. The fourth solenoid valve 56 is fluidly connected to a second pressure indicator 58 and a second pump 60, such as a 250 gpm pump. The second pump 60, in turn, is fluidly connected to a high temperature switch 62 and a filter housing 64. The filter housing 64 has a back pulse line 66 (discussed later), a water tap 68, and a return line 70. The return line 70 is fluidly connected back to the second pump 60 via a second return line 72 and a reducing valve 74. The reducing valve 74 is fluidly connected to (i) a system reservoir 76, which includes a high level switch 78 and a low level switch 80; (ii) a water drain solenoid valve 82, and (iii) the second solenoid valve 42.

With continuing reference to FIG. 3, the filter housing 64 holds a filter 24, such as the filter 24 described above. The back pulse line 66 fluidly connects the filter housing 64 to a back-pulsing unit 84. More particularly, the back-pulsing unit 84 may include an accumulator 86, a fifth solenoid valve 88, a pressure gauge 90, a third pressure indicator 92, a prefilter 94, a sixth solenoid valve 96, a second relief valve 98, a third pump 100, a third reservoir 102, and a seventh solenoid valve 104. The accumulator 86 is also fluidly connected to the back pulse line 66 via the fifth solenoid valve 88. The back pulse line 66 is also fluidly connected to the third pressure indicator 92 and the sixth solenoid valve 96. The accumulator 86 is fluidly connected to the prefilter 94, and the second pressure indicator 92 is fluidly connected to the prefilter 94. The prefilter 94 is fluidly connected to the third pump 100 and to the second relief valve 98. The second relief valve 98 and the third pump 100 are both fluidly connected to the third reservoir 102. The seventh solenoid valve 104 is fluidly connected to the third reservoir 102 and the sixth solenoid valve 96. An exit line 106 is fluidly connected to the sixth solenoid valve 96 and the seventh solenoid valve 104.

The back-pulsing unit 84 is designed to periodically send a fluid pulse in a direction opposite to the direction of fluid flow, such as twice per minute, with the fluid pulse preferably lasting about one second. The back pulse helps prevent clogging of the filter element 10 caused by fluid forces.

In one method of separating water from a wet petroleum-based fluid, a filter 24 having at least one filter element 10 is provided. As stated above and shown in FIG. 1, each filter element 10 includes the hollow, porous support structure 12, the porous first ceramic coating 16 positioned adjacent to the porous support structure 12, and the porous second ceramic coating 20 positioned adjacent to the first ceramic coating 16.

The next step is soaking the filter 24, shown in FIG. 2, with a dry petroleum-based fluid. The soaking step is believed to coat the filter 24 and permeate the pores of the support structure 12, the porous first ceramic coating 16, and the porous second ceramic coating 20 with a thin film of the dry petroleum-based fluid. It has been found that the soaking step can be accomplished by flushing the filter 24 with dry petroleum-based fluid for approximately one to three hours.

Once the filter 24 has been soaked, the next step is installing the soaked filter 24 in the filter housing 64 of the filtration system shown in FIG. 3. Once the filter 24 is installed, the first pump 40 feeds a wet petroleum-based fluid from the first reservoir 36 to the second pump 60. The second pump 60 agitates the wet petroleum-based fluid to form an emulsion of water droplets and petroleum-based fluid, with the water droplets preferably having a size of approximately 0.2 microns in diameter. The emulsion is then cross fed through the filter 24 in the filter housing 64 at a high velocity, such as approximately 7-15 feet per second. It is believed that the cross flow produces a pressure differential which helps to induce a flow within the thin film provided by the soaking process that generates a low water, high-molecular weight permeate flow on the low-pressure side of the first and second ceramic coatings 16, 20. The water droplets isolated by the first and second pores 18, 22 defined by the first and second ceramic coatings 16, 20 are carried by the cross flow, resulting in the exclusion of the water droplets from the permeate flow. The cross flow is also believed to help replace the dry petroleum fluid lost to the permeate flow flowing through the first and second ceramic coatings 16, 20 of each filter element 10 and the crossflow is believed to reduce membrane fouling.

The cross flow fluid pressure during filtration should be approximately 50-60 lbs/in² for kerosene and approximately 60-80 lbs/in² for oil. Pressures less than these values may generate unacceptably low permeate flows, while excessive pressures may create partially filtered permeate flows that include coalesced water. Permeate flow is herein defined as the fluid that exits the filter element 10.

As the emulsion cross flows through the filter element or elements 10, water separated from the emulsion and some of the emulsion flow out of the filter housing 64. A portion of the water and the emulsion passes through the reducing valve 74 and into the second reservoir 76 for gravity settling. The remaining water and the emulsified fluid are then routed back to the second pump 60 for re-emulsification and re-filtration.

As filtration continues over time, the efficiency of the filter 24 can deteriorate due to clogging of the fluid permeable pores defined by the first and second ceramic coatings 16, 20 of the filter element 10. Therefore, the back-pulsing unit 84 can be used to momentarily reverse the permeate flow through the filter elements 10 and effectively unclog the filter 24. In the filtration system shown in FIG. 3, the accumulator 86 and the third reservoir 102 hold a dry petroleum-based fluid. When back-pulsing is warranted, the third and fifth solenoid valves 54, 88 open, and sixth solenoid valve 96 closes. The valves may be activated and deactivated by PLC logic. Dry petroleum-based fluid in the actuator 86 is forced through the back pulse fluid line 66 at approximately 150 lbs/in² in a reverse permeate flow direction through the filter element or elements 10 in the filter 24. Once back-pulsing is accomplished, for example, after approximately one second, valves 54 and 88 close, valve 96 opens, and the third pump 100 resupplies the accumulator 84 with a dry petroleum-based fluid. The amount of dry petroleum-based fluid in the third reservoir 102 is regulated by the seventh solenoid valve 104, which opens to allow fluid to enter the third reservoir 102.

### TEST RESULTS

To demonstrate the versatility of the present invention to separate water from wet petroleum-based fluids, experiments were conducted using kerosene/water and hydraulic oil/water emulsions. The equipment and techniques used in these experiments are described below.

A. Petroleum-Based Products

The petroleum-based products used in the experiments were kerosene and hydraulic oil. Kerosene was K-1 type that contained a red dye. The hydraulic oil was an ISO 32 grade. Both liquids were used as obtained without prior purification.

B. Filters

The filters 24 used in the experiments were of the type described in detail above. The filters 24 were 1.2 m long, had a 0.2 m² of surface area, and each contained nineteen filter elements 10. Table 1 describes the coating thickness, pore diameter and compositions, of the filter element 10 used in these experiments.

TABLE 1
Coating-Wise Description of Filter Elements

| | | Pore | |
|---|---|---|---|
| Coating | Composition | Diameter | Coating Thickness |
| 1 | Activated Alumina | 0.2 μm | 10 μm |
| 2 | Activated Alumina | 0.8 μm | 20 μm |
| Support Structure | Activated Alumina | 5 μm | 6.35 μm |

C. Test Equipment

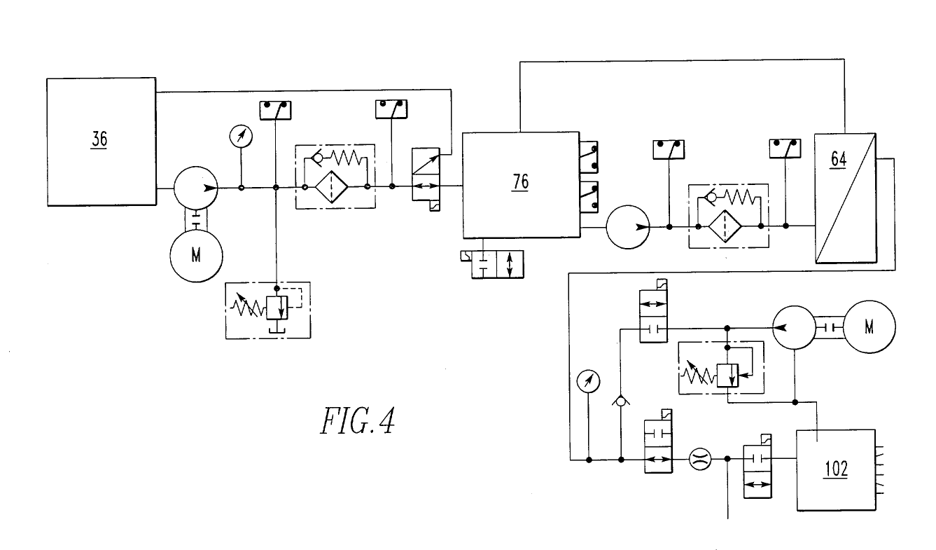

The test bench used in the experiments is shown schematically in FIG. 4. The test bench is similar to the filtration system discussed above; with like reference numerals indicating like parts. The capacities, in gallons, for the first, second, and third reservoirs 36, 76, 102 were 20.5, 8.5, and 6 gallons, respectively. Water concentrations expressed in ppm were determined using the Karl Fisher titration method, while those expressed in percent water resulted from volumetric calculations.

D. Test Procedures

The procedure followed for both the oil/water and kerosene/water separation experiments is detailed below.

1. Oil/Water Separation Experiment

Oil/water separation experiments were conducted by filling the first, second, and third reservoirs with oil and pumping the liquid through the test bench to flush the system. Filtration of the oil was provided to remove particulate materials as necessary. After the system was flushed, a virgin oil sample was collected as a control. After collection of the control, the test bench was shut down, and a pre-soaked filter 24 was installed in the filter housing 64. The test bench was restarted, and the pressure downstream of the filter 24 was set to a test pressure of 60 lbs/in². Back-pulsing pressure was set to 80 lbs/in². Approximately 0.2 gallons of water was added to the first reservoir and mixed with an offline filtration device for thirty minutes to generate a uniform emulsion. Samples from each of the reservoirs were collected at fixed intervals. During the experiment, the temperature of the system was maintained between 80-150° F., ceramic downstream pressure at approximately 60 lbs/in², and back-pulsing pressure at approximately 100 lbs/in². Water concentrations in each of the samples were determined using the Karl Fisher titration technique.

2. Oil/Water Separation Experiment Results

The first, second, and third reservoirs had initial water concentrations of 12,609, 107, and 89 ppm, respectively, and initial temperatures of 90° F., 100° F., and 140° F., respectively. Cross flow pressures remained in the range of 70-80 lbs/in² upstream and 60 lbs/in² downstream of the filter 24 throughout the experiment. Back-pulse pressures remained in the range of 150-160 lbs/in².

Over the duration of the experiment, samples were collected from the three reservoirs to generate a time-dependent picture of water transfer between the reservoirs. Trends for the reservoirs were as follows: first reservoir oil decreased from a water concentration of 12,609 ppm to a final water concentration of 443 ppm; second reservoir oil climbed from 107 ppm water to a final water concentration of 25,981 ppm; and the third reservoir oil rose slightly from 89 ppm water to a final water concentration of 322 ppm water.

The first reservoir, which had 0.2 gallons of water added to it, experienced a decrease in its initial water content from 12,609 ppm to 443 ppm over the duration of the experiment, a 27+fold reduction in water concentration. The water concentration of the first reservoir 36 decreased in step with the increase in water of the second reservoir 76. The water concentration in the second reservoir 76 pinnacled at 25,981 ppm water.

Samples of permeate oil, after subjection to filtration for 6.5 hours, were obtained from the permeate reservoir as clear, hot (110° F.) oil. Upon standing and cooling, these samples developed a slight cloudy appearance, which was later determined to be a slight water emulsion. This emulsion resulted from saturation of the oil with water at above-ambient temperatures.

Turbine oil at room temperature (70° F.) is saturated at 50 ppm H₂O; 115° F., 90 ppm H₂O; and 160° F., 200 ppm H₂O. If this oil is saturated with water at 160° F., it will hold approximately 200 ppm of water. When this oil is returned to the reservoir to cool to 115° F., the oil will be supersaturated with water and the difference (110 ppm of water) will separate from the oil to form either an emulsion or free water. For this reason, selection of an optimum operating temperature is a compromise between maximizing separation efficiency, while minimizing the formation of emulsion and free water in the treated oil. For this reason, recommended operating temperature should not be outside the range of 100° F. to 120° F.

3. Kerosene/Water

The investigation of kerosene/water emulsion separation using ceramic coatings was conducted in two separate experiments. The first experiment had a single water addition and was designed to monitor water transfer in the test system over the duration of the experiment. The second experiment had multiple water additions to determine the maximum water content a kerosene/water emulsion could possess before the operation of the filter element failed.

a. Kerosene/Water Separation Experiment No. 1—Single Water Addition

Single water addition kerosene/water separation experiments were conducted by filling the first, second, and third test bench reservoirs with kerosene and pumping the kerosene through the test bench to flush the system. Filtration of the kerosene was provided to remove particulate materials as necessary. After the system was flushed, a virgin kerosene sample was collected as a control. After collection of the control, the test bench was shut down, and a filter 24 pre-soaked with kerosene was installed in the filter housing 64. The test bench was restarted and the pressure downstream of the filter was set to approximately 60 lbs/in². Back-pulsing was set to approximately 100 lbs/in².

Approximately 0.2 gallons of water was added to the first reservoir 36 and mixed with an offline filtration device for thirty minutes to generate a uniform emulsion. Samples from the first, second, and third reservoirs 36, 76, 102 were collected at fixed intervals. During the experiment, the temperature of kerosene in the second reservoir was maintained between 90-100° F. Water concentrations in each of the samples were determined using the Karl Fisher titration technique.

b. Kerosene/Water Separation Experiment No. 1—Single Water Addition Results

Kerosene in the first and third reservoirs 36, 102 had initial water concentrations of 3,560 ppm and 92 ppm, respectively. Water concentrations were not monitored in the second reservoir 76. Filter 24 cross flow pressures remained in the range of 70-80 lbs/in² upstream and 60 lbs/in² downstream of the filter 24 throughout the experiment. Back-pulsing pressures held constant at 100 lbs/in².

Over the course of the experiment, the third reservoir 102 had water concentrations in the 82-96 ppm range and a terminal water concentration of 57 ppm to a terminal concentration of 94 ppm. Permeate flow rates were sustained between 0.5 and 0.6 gallons/min.

c. Kerosene/Water Separation Experiment No. 1—Multiple Water Addition

Multiple-water-addition kerosene/water separation experiments were conducted by filling the test bench reservoirs with kerosene and pumping the kerosene through the test bench to flush the system. Filtration of the kerosene was provided to remove particulate materials as necessary. After the test bench was flushed, a virgin kerosene sample was collected as a control. After collection of the control, the system was shut down and a pre-soaked filter 24 was installed in the coating housing 64. The test bench was restarted and the pressure downstream of the filter 24 was set to a test pressure of 50 lbs/in². Back-pulsing pressure was set to 80lbs/in².

Approximately 0.2 gallons of water were added to the first reservoir 36 and mixed with an offline filtration device for thirty minutes to generate a uniform emulsion. Samples from the third reservoir 102 were collected at thirty minute intervals. 0.2 gallons of kerosene was then removed from the third reservoir 102 and an equal volume of water was added to the first reservoir 36 to account for the removed volume. This cycle of permeate kerosene removal and water replacement was repeated until a 50% water concentration in the second reservoir was achieved. During the experiment, the temperature of the second reservoir kerosene was maintained between 70-90° F., coating downstream pressure at 50 lbs/in², and back-pulsing pressure at 80 lbs/in². Water concentrations in each of the samples were determined using the Karl Fisher titration technique.

d. Kerosene/Water Separation Experiment No. 1—Multiple Water Addition Results

Kerosene in the third reservoir 102 had an initial water concentration of 59 ppm. Water concentrations were not monitored in the first and second reservoirs. The very high water concentrations (10-50%) consume excessive amounts of KF titrants and fine concentration determinations were beyond the scope of this experiment. Samples of kerosene from the third reservoir 102 were collected at approximately thirty minute intervals. Filter element 10 cross flow pressures upstream and downstream of the coating remained at 50 lbs/in² throughout the experiment. Back-pulsing held constant at 80 lbs/in².

As the experiment proceeded, the water concentration in the third reservoir 102 fluctuated in the range of 49-121 ppm. At the termination of the experiment, the third reservoir 102 had a water concentration of 49 ppm. Permeate flow remained constant with the additions of water 10%, 20%, and 30% of the second reservoir 76, yet decreased substantially from a starting flow of 0.60 to 0.03 gallons/min upon reaching a second reservoir 76 water concentration of 50%.

These experiments demonstrate the ability of the soaked ceramic coatings to separate water from kerosene/water emulsions. In the multiple-water-addition experiment, permeate kerosene water concentration was found not to be dependent on the water concentration of the cross flow solution, despite the large quantity water present. In fact, the experiment was halted at 50% kerosene/water only.

The invention has been described with reference to the preferred embodiments. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A filter element for separating a water from a petroleum-based fluid, the filter element comprising:
a hollow, fluid permeable porous support structure, a fluid permeable first ceramic coating positioned adjacent to the support structure, and a fluid permeable second ceramic coating positioned adjacent to the fluid permeable first ceramic coating; and
a thin film of dry petroleum-based fluid,
wherein the thin film of dry petroleum-based fluid substantially coats the filter element and permeates the fluid permeable porous support structure, the fluid permeable first ceramic coating, and the fluid permeable second ceramic coating, the dry petroleum-based fluid having a water content of approximately 100 ppm or less.

2. The ceramic filter element as claimed in claim 1, wherein the hollow, fluid permeable porous support structure is made from alumina.

3. The ceramic filter element as claimed in claim 1, wherein the hollow, fluid permeable porous support structure has an average pore size of approximately 5 microns.

4. The ceramic filter element as claimed in claim 1, wherein the hollow, fluid permeable porous support structure has a thickness of approximately 0.25 inch.

5. The ceramic filter element as claimed in claim 1, wherein the fluid permeable first ceramic coating is made from the group consisting of α-activated alumina and zirconia.

6. The ceramic filter element as claimed in claim 1, wherein the fluid permeable first ceramic coating has an average pore size of approximately 20 microns.

7. The filter as claimed in claim 1, wherein the fluid permeable second ceramic coating is made from a material selected from the group consisting of α-activated alumina and zirconia.

8. The filter as claimed in claim 1, wherein the fluid permeable second ceramic coating has an average pore size of approximately 0.2 microns.

9. The filter as claimed in claim 1, wherein the fluid permeable second ceramic coating has a thickness of approximately 10 microns.

10. A method of separating water from a wet petroleum-based fluid comprising the steps of:
a. providing a filter element comprising a hollow, fluid permeable porous support structure, a fluid permeable first ceramic coating positioned adjacent to the hollow, fluid permeable porous support structure, and a fluid permeable second ceramic coating positioned adjacent to the fluid permeable first ceramic coating;
b. soaking the ceramic filter element with a dry petroleum-based fluid, the dry petroleum-based fluid having a water content of approximately 100 ppm or less;
c. flowing a wet petroleum-based fluid contaminated with water through the hollow, fluid permeable support structure, the fluid permeable first ceramic coating, and the fluid permeable second ceramic coating; and
d. removing water from the wet petroleum-based fluid.

11. The method as claimed in claim 10, further comprising the step of agitating the wet petroleum fluid to form an emulsion of water and a petroleum-based fluid, after the step of soaking the filter element and prior to the step of flowing the wet petroleum-based fluid through the filter element.

12. The method as claimed in claim 11, wherein the step of flowing the wet petroleum-based fluid through the filter element is done by pumping the wet petroleum-based fluid through the filter element at approximately 7-15 feet per second.

13. The method as claimed in claim 11, further comprising the step of back-pulsing a dry petroleum fluid through the filter element in a periodic increment after the step of removing water from the wet petroleum-based fluid.

14. The method as claimed in claim 13, wherein the periodic increment is one second twice per minute.

15. The method as claimed in claim 11, further comprising the step of substituting alumina with zirconia in the fluid permeable second ceramic coating to switch from separation to coalescence.

16. The method as claimed in claim 15, further comprising the step of substituting the zirconia with alumina to switch from coalescence to separation.
